(19) United States
(12) Patent Application Publication
(10) Pub. No.: US 2016/0065657 A1
(43) Pub. Date: Mar. 3, 2016

(54) MESSAGE AND SUBSCRIPTION INFORMATION PROCESSING

(71) Applicant: International Business Machines Corporation, Armonk, NY (US)

(72) Inventors: Yi Ge, BEIJING (CN); Qi Yu, BEIJING (CN); Guotao Zhao, BEIJING (CN); Yu Chen Zhou, BEIJING (CN)

(21) Appl. No.: 14/836,159

(22) Filed: Aug. 26, 2015

(30) Foreign Application Priority Data
Aug. 29, 2014 (CN) 201410433303.2

(51) Int. Cl. H04L 29/08; H04L 12/58

(52) U.S. Cl. CPC H04L 67/10; H04L 51/36; H04L 67/306

(57) ABSTRACT

A method and system for processing a message and subscription information is provided. Subscription information is obtained and parsed into a first set of predicates, whereby these predicates are not repetitive. One or more tree structures for the predicates and the subscription information are constructed based on possibilities of the predicates in hitting a message. The possibility of the predicate for a lower internal node in the tree structure hitting the message is higher than that of an upper internal node. Each of the subscription information corresponds to one leaf node in one tree structure, and each of the subscription information corresponds to all information of the predicates in a branch of the leaf node in the tree structure thereof from the root node. The one or more tree structures for matching with the message are stored.

### BACKGROUND

The present invention relates to information processing. Particularly, the present invention relates to methods and systems for processing a message and subscription information. More particularly, the present invention relates to methods and systems for processing a message and subscription information in the internet of things (IOT).

With the development of information technology, network technology is increasingly developed. Currently, there are many kinds of network, such as the Internet, the internet of things, the internet of vehicles, etc. The internet of things is an important component of the new generation information technology and particularly refers to object-interconnecting networks. Particularly, the internet of things refers to the huge network in conjunction with the Internet, by sampling in real time any objects or procedures to be monitored, connected or interconnected and collecting acoustical, optical, thermal, mechanical, chemical, biological, position and various required information, through various information sensing devices, such as sensors, RFID techniques, the GPS system, infrared sensors, laser scanners, gas transducers, and other various apparatus and techniques. The object of the internet of things is to realize connections between objects, objects and persons, all things and networks for the convenience of identification, management and control.

### SUMMARY

According to an embodiment, a method for processing subscription information is provided. The method includes: obtaining one or more pieces of first subscription information and parsing the one or more pieces of first subscription information into a first set of predicates, in which the predicates are not repetitive. The method includes constructing one or more tree structures for the predicates in the first set and the first subscription information based on possibilities of the predicates in the first set hitting messages. The internal nodes in the tree structure including a root node represent the predicates, leaf nodes of the tree structure represent the subscription information. In the method, the possibility of the predicate for a lower internal node in the tree structure hitting the messages is higher than that of an upper internal node, each of the first subscription information corresponds to only one leaf node in one tree structure, and each of the first subscription information corresponds to all information of the predicates in a branch of the leaf node in the tree structure thereof from the root node. In the method, the one or more tree structures for matching with the message is stored.

According to another embodiment, a method for matching a message with subscription information is provided. The method includes obtaining tree structures associated with the subscription information, whereby the subscription information is parsed into a set of predicates. In the method, the predicates are not repetitive, the tree structures are constructed for the predicates in the set and the subscription information based on possibilities of the predicates in the set hitting messages. Internal nodes in the tree structure including a root node represent the predicates, leaf nodes of the tree structure represent the subscription information. The possibility of the predicate for a lower internal node in the tree structure hitting the messages is higher than that of an upper internal node, each of the subscription information corresponds to and only corresponds to one leaf node in one tree structure, and each of the subscription information corresponds to all information of the predicates in a branch of the leaf node in the tree structure thereof from the root node. The method includes obtaining the message and evaluating the message based on the set of predicates to obtain a predicate result vector, each element in the predicate result vector corresponding to a respective predicate in the set of predicates. The method includes traversing the tree structures for each element in the predicate result vector to obtain the subscription information matching with the message.

According to still another embodiment, a method for processing a message and subscription information is provided. The method includes obtaining the message. The method includes dynamically selecting a subscription information priority mode and a predicate priority mode to obtain subscription information matching with the message, whereby in the subscription information priority mode subscription information is obtained. The subscription information is parsed into a set of predicates, in which the predicates are not repetitive. The message is evaluated based on the set of predicates to obtain a predicate result vector, each element in the predicate result vector corresponding to a respective predicate in the set of predicates. Each subscription information is checked on a one-by-one basis for the predicate result vector to obtain the subscription information matching with the message. In the predicate priority mode, the message is matched with subscription information using the above method.

According to another embodiment, a computer system for processing subscription information is provided. The computer system includes one or more processors, one or more computer-readable storage devices, and a plurality of program instructions stored on at least one of the one or more storage devices for execution by at least one of the one or more processors. The program instructions obtain one or more pieces of first subscription information. The program instructions parse the one or more pieces of first subscription information into a first set of predicates, in which the predicates are not repetitive. The program instructions construct one or more tree structures for the predicates in the first set and the first subscription information based on possibilities of the predicates in the first set hitting messages. The internal nodes in the tree structure including a root node represent the predicates. Leaf nodes of the tree structure represent the subscription information, the possibility of the predicate for a lower internal node in the tree structure hitting messages is higher than that of an upper internal node. Each of the first subscription information corresponds to one leaf node in one tree structure, and each of the first subscription information corresponds to all information of the predicates in a branch of the leaf node in the tree structure thereof from the root node. Program instructions store the one or more tree structures for matching with the message.

According to still another embodiment, a computer system for matching a message with subscription information is provided. The computer system includes one or more processors, one or more computer-readable storage devices, and a plurality of program instructions stored on at least one of the one or more storage devices for execution by at least one of the one or more processors. The program instructions obtain tree structures associated with the subscription information. The subscription information is parsed into a set of predicates, in which the predicates are not repetitive, the tree structures are constructed for the predicates in the set and the subscription information based on possibilities of the predicates in the set hitting messages. Internal nodes in the tree structure including a root node represent the predicates, leaf nodes of the tree structure represent the subscription information, the possibility of the predicate for a lower internal node in the tree structure hitting messages is higher than that of an upper internal node, each of the subscription information corresponds to and only corresponds to one leaf node in one tree structure, and each of the subscription information corresponds to all information of the predicates in a branch of the leaf node in the tree structure thereof from the root node. Program instructions obtain the message. Program instructions evaluate the message based on the set of predicates to obtain a predicate result vector, each element in the predicate result vector corresponding to a respective predicate in the set of predicates. Program instructions traverse the tree structures for each element in the predicate result vector to obtain the subscription information matching with the message.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 shows the basic principle of the method of “test network” in the prior art.

FIG. 2 shows the basic principle of the method of “two phases” in the prior art.

FIG. 3 shows an exemplary computer system/server 12 which is applicable to implement the embodiments of the present invention.

FIG. 4 shows a flowchart of a method for processing subscription information according to an embodiment of the present invention.

FIG. 5 shows an exemplary tree structure according to an embodiment of the present invention.

FIG. 6 shows a flowchart of a method for processing subscription information according to an embodiment of the present invention.

FIG. 7 shows a flowchart of a method for matching a message with subscription information according to an embodiment of the present invention.

FIG. 8 shows a schematic view of a method for matching a message with subscription information according to an embodiment of the present invention.

FIG. 9 shows a flowchart of a method for processing a message and subscription information according to an embodiment of the present invention.

FIG. 10 shows a functional block diagram of a system 5000 for processing subscription information according to an embodiment of the present invention.

FIG. 11 shows a functional block diagram of a system 6000 for matching a message with subscription information according to an embodiment of the present invention.

FIG. 12 shows a functional block diagram of a system 7000 for processing a message and subscription information according to an embodiment of the present invention.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”, “module”, or “system”. Furthermore, aspects of the present invention may take the form of a computer program product embodied in one or more computer readable medium(s) having computer readable program code embodied thereon.

Aspects of the present disclosure are described below with reference to flowchart illustrations and/or block diagrams of methods, apparatus, (systems), and computer program products according to embodiments of the invention. It will be understood that each block of the flowchart illustrations and/or block diagrams, and combinations of blocks in the flowchart illustrations and/or block diagrams, can be implemented by computer program instructions.

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein.

An internet of things (IOT) includes applications, application infrastructures, a wide area network (WAN), an access network, and a sensor network. The sensor network includes a plurality of sensor devices that collect data information externally. The data information is transmitted to the application infrastructures through the WAN. The application infrastructures include an information database and application gateways. The information database stores the obtained information, and the application gateways filter and distribute data (i.e., publish). The applications may send requests to the application gateways to obtain the required information (i.e., subscribe). This model is referred to as a publish/subscribe mode.

In a publish/subscribe mode, an application infrastructure distributes data, i.e., publish, and the application sends requests for information to the application infrastructure gateways (i.e., subscribe). The current publish/subscribe mode mainly includes a topic-based publish/subscribe mode and a content-based publish/subscribe mode. In the topic-based publish/subscribe mode, messages are published to topic or command channels. The subscribers will receive all the messages about the topic they subscribe, and all the subscribers who subscribe the same topic will receive the same messages. In the content-based publish/subscribe mode, the subscribers define the subscription information, i.e., the conditions (rules) for the messages of interest. Only when a property or content of a message satisfies the condition defined by the subscriber, the message will be posted to the subscriber. Since the content-based publish/subscribe mode is more flexible than the topic-based publish/subscribe mode, the content-based publish/subscribe mode is widely used in the field of the internet of things.

Since the amount of data is huge in the internet of things and each piece of data should be matched with a set of rules, the processing of the subscription information and messages should occur in the application gateway. In addition, there are also publish/subscribe mechanisms for other kinds of networks (such as Internet). Since the amount of data in the networks is continually increasing, the processing of the subscription information and messages in these networks should be addressed as well.

In the content-based publish/subscribe mode, the rules of the subscription information can be divided into a combination of predicates. The so-called predicates are the smallest divisible unit of a rule. For example, the following subscription information can be defined:

(Pressure>30) & (Status=“stable”),

in which the rules in the subscription information is a set of two predicates, and the two predicates are:

Predicate 1: Pressure>30 (representing that the pressure is greater than 30); and

Predicate 2: Status=“stable” (representing that the status is stable).

All the messages which satisfy the above two predicates will be distributed to the particular message queue.

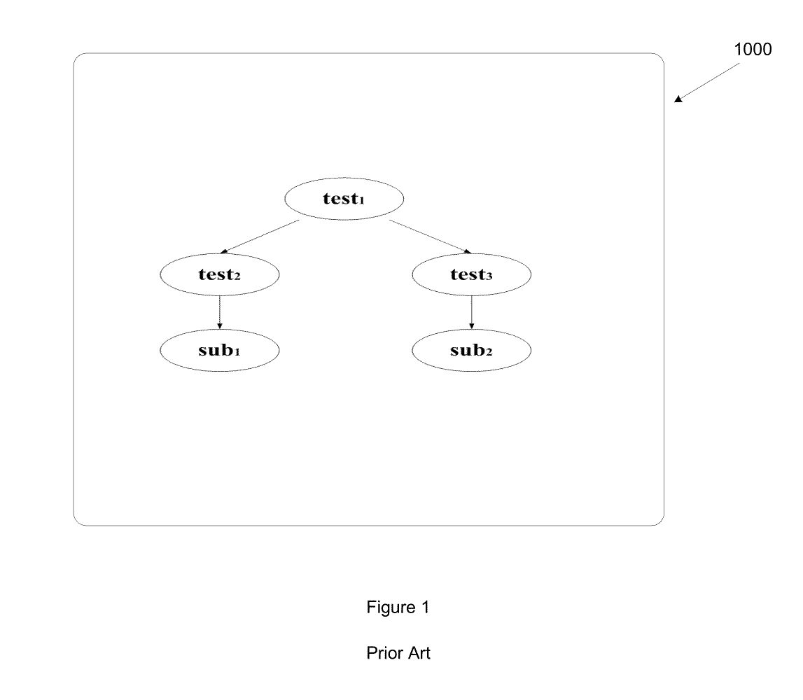

FIG. 1 shows the basic principle of the method 1000 of “test network”. For example, in the internet of things, in order to process the messages and the subscription information, a method of test network may be implemented. In a test network, the predicates and the subscription information are compiled into a test network, i.e., a tree structure. The internal nodes (such as test₁, test₂ and test₃) of the tree structure store the predicates to be tested, and the leaf nodes (such as sub₁ and sub2) of the tree structure represent the subscription information. In the method of test network, each of the subscription information is represented by one or more leaf nodes, and corresponds to all information of the predicates in a branch of the leaf node in the tree structure thereof from the root node. For the message in the internet of things, evaluation is made from the root node of the tree structure, and all of the internal nodes are traversed to find the matching internal nodes, thus the matching subscription information can be obtained.

However, the test network approach consumes a large storage space, and is complex and expensive when new subscription information is inserted or the subscription information is updated, thereby making the test network unsuitable to the case in which the subscription information is changed rapidly. However, in the field of the internet of things, the applications and the users submit a large quantity of different subscription information dynamically, so it is difficult for this method to be suitable to the development of the technology of the internet of things.

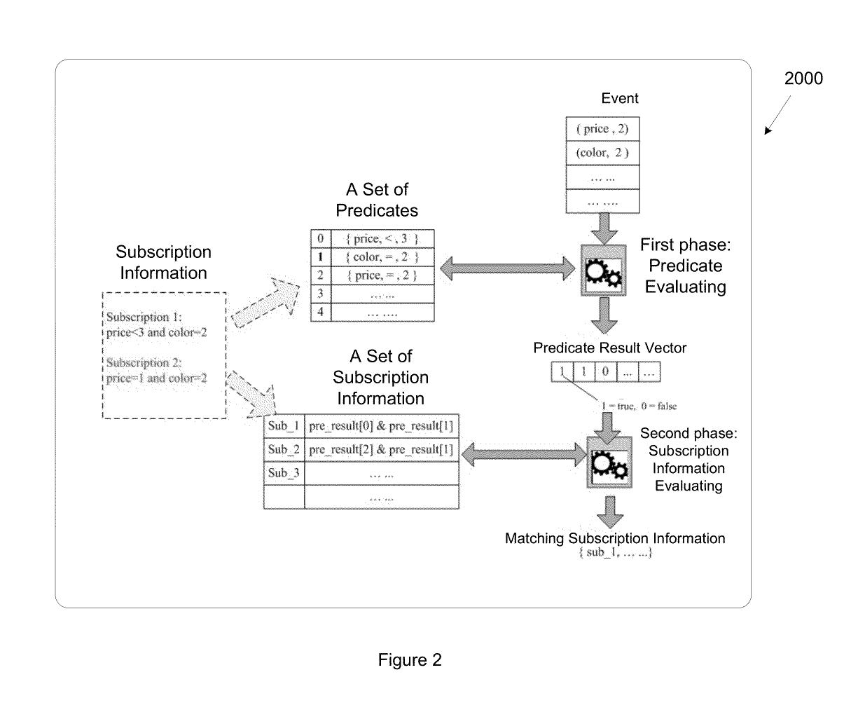

FIG. 2 shows the basic principle of the method 2000 of “two phases”. In this method, the subscription information from a user is firstly divided into a set of predicates, and the repetitive predicates are removed. In the first phase, each of the input messages is evaluated sequentially based on every predicate in the set of predicates to generate a predicate result vector for the message. Each bit in the predicate result vector corresponds to a respective predicate in the set of predicates. If the message hits the predicate (i.e., satisfies the predicate), the value of the corresponding bit in the predicate result vector is “1”, or else it is “0”. In the second phase, as to the predicate result vector, each of the subscription information is checked, that is, all the subscription information is traversed to obtain a list of matching subscription information. During the process of traversing for a piece of subscription information, if all the values of bits in the predicate result vector of the message for the predicates of the subscription information are “1”, it is indicates that the message satisfies all the predicates of the subscription information, that is, the message matches with the subscription information.

In the method of two phases, the time for evaluating the predicates can be reduced, and the evaluating results can be shared. However, if there is a large quantity of content-based subscription information, since the amount of the subscription information to be evaluated is large, the performance of system and the throughput sharply decrease. Queue blocking and queue dumping occurs, and the sensors in the internet of things cannot transmit data as rapidly as required.

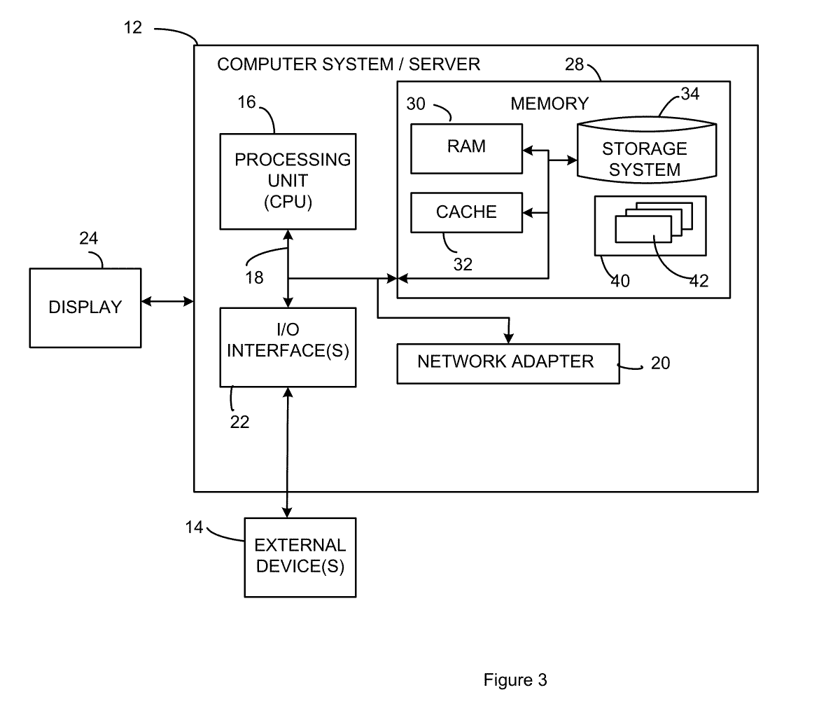

Referring now to FIG. 3, an exemplary computer system/server 12 which is applicable to implement the embodiments of the present invention is shown. Computer system/server 12 is only illustrative and is not intended to suggest any limitation as to the scope of use or functionality of embodiments of the invention described herein.

The components of computer system/server 12 can include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via input/output (I/O) interfaces 22. Computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Below, embodiments and examples of the present invention will be described with reference to the accompanying drawings, in which repetitive portions may be omitted.

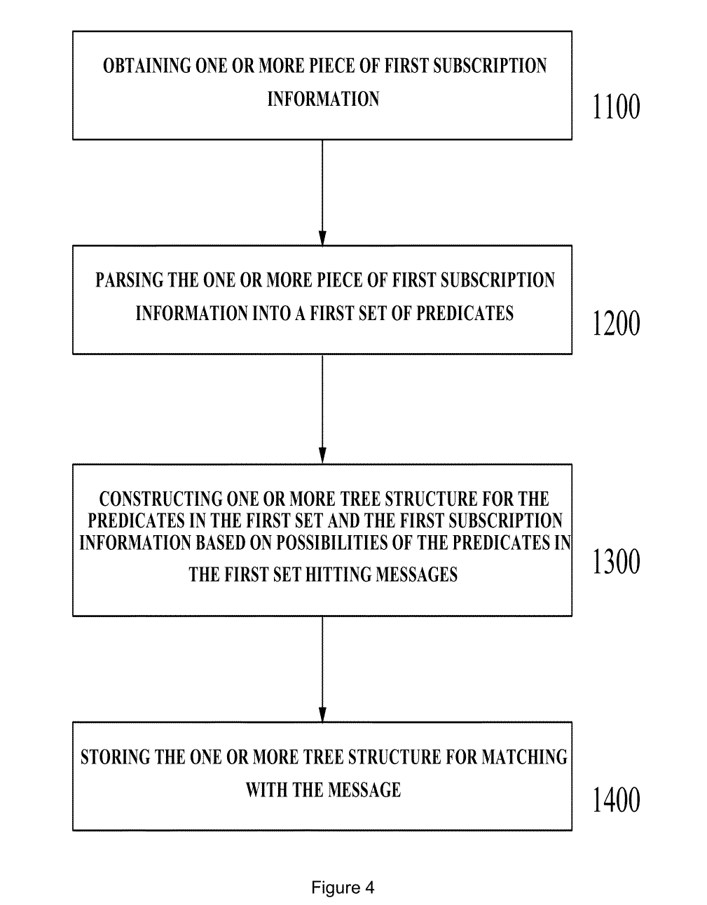

FIG. 4 shows a flowchart of a method for processing subscription information according to an embodiment. For example, this method can be used in the internet of things.

First, in step 1100, one or more pieces of first subscription information is obtained.

In step 1200, the one or more pieces of first subscription information is parsed into a first set of predicates, whereby the predicates in the first set are not repetitive, that is, the repetitive predicates are removed.

In step 1300, one or more tree structures is constructed for the predicates in the first set and the first subscription information based on possibilities of the predicates in the first set hitting messages, whereby internal nodes in the tree structure including a root node represent the predicates, leaf nodes of the tree structure represent the subscription information, the possibility of the predicate for a lower internal node in the tree structure hitting the messages is higher than that of an upper internal node, each of the first subscription information corresponds to and only corresponds to one leaf node in one tree structure, and each of the first subscription information corresponds to all information of the predicates in a branch of the leaf node in the tree structure thereof from the root node. The message is the message in the internet of things.

The possibility of a predicate hitting messages refers to the possibility that the message satisfies the predicate (i.e., satisfies the rule associated with the predicate). This possibility is obtained by the system according to the statistical data.

In the method according to the present invention, the possibility of the predicate for a lower internal node in the tree structure hitting the messages is higher than that of an upper internal node, so the predicate for the root node of the tree structure is the predicate of the least possibility for matching with the message.

Referring back to FIG. 4, in step 1400, the one or more tree structures is stored for matching with the message.

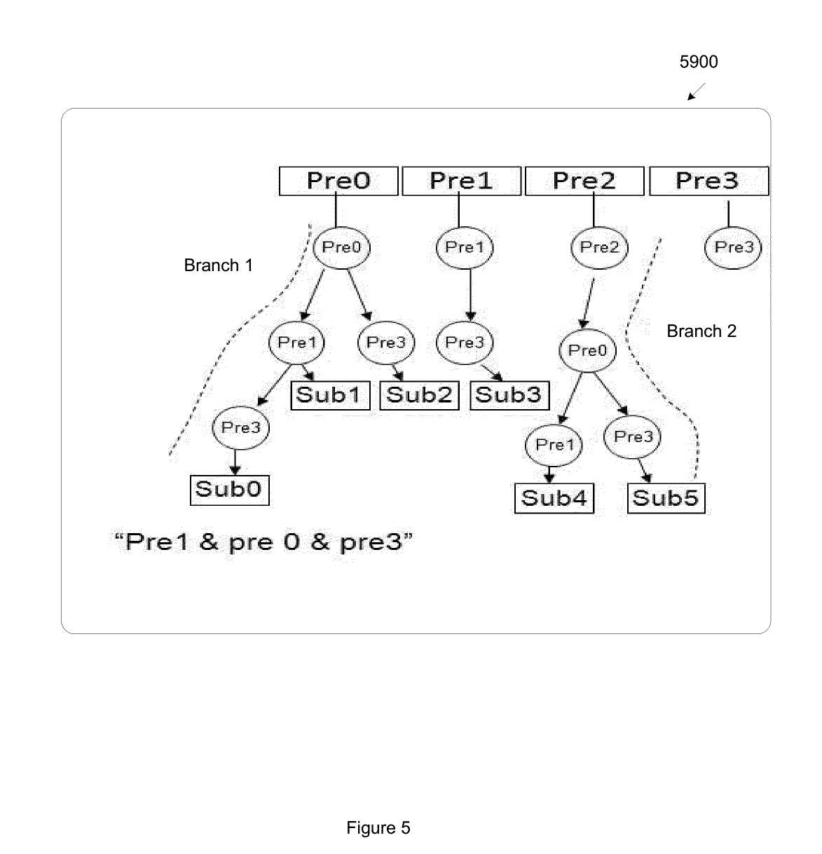

FIG. 5 shows an exemplary tree structure 5900 according to an embodiment of the present invention. In this example, the obtained subscription information and the predicates included in the subscription information are shown in Table 1.

TABLE 1
Subscription information and predicates included in the subscription
information

| Subscription | Predicates |
|---|---|
| Sub0 | Pre0&Pre1&Pre3 |
| Sub1 | Pre0&Pre1 |
| Sub2 | Pre0&Pre3 |
| Sub3 | Pre1&Pre3 |
| Sub4 | Pre0&Pre1&Pre2 |
| Sub5 | Pre0&Pre2&Pre3 |

In this example, six pieces of subscription information, i.e., Sub0, Sub1, . . . , Sub5, are obtained. The six pieces of subscription information may be parsed into a set of predicates comprising four predicates which are not repetitive. The four predicates which are not repetitive are Pre0, Pre1, Pre2 and Pre3, respectively. In Table 2, the possibilities of the four predicates hitting messages are shown.

TABLE 2
Possibilities of predicate hitting messages

| Predicate | Possibilities of predicate hitting messages |
|---|---|
| Pre0 | 20% |
| Pre1 | 30% |
| Pre2 | 10% |
| Pre3 | 40% |

The tree structures generated according to the method of the present invention are shown in FIG. 5. As shown in FIG. 5, the internal nodes in the tree structure represent the predicates, the leaf nodes of the tree structure represent the subscription information, and each of the subscription information corresponds to only one leaf node in one tree structure. Since the possibility of the predicate for a lower internal node in the tree structure hitting the messages is higher than that of an upper internal node, for example, as to the predicate Pre0 (the possibility hitting the messages thereof is 20%), the lower internal nodes of Predicate Pre0 merely can be Pre1 (30%) and Pre3 (40%), the possibilities of which are higher than Pre0, and cannot be Pre2 (10%), the possibility of which is lower than Pre0.

As also shown in FIG. 5, each of the subscription information corresponds to all information of the predicates in a branch of the leaf node in the tree structure thereof from the root node. For example, as to Sub0, it corresponds to all of the predicates Pre0, Pre1 and Pre3 in “Branch 1”. As to Sub5, it corresponds to all of the predicates Pre2, Pre0 and Pre3 in “Branch 2”.

If the possibilities of two predicates hitting messages are identical, the two predicates may be sequenced according to their index numbers, so long as each of the subscription information corresponds to only one leaf node in one tree structure. Since the possibility of the predicate for a lower internal node in the tree structure hitting the messages is higher than that of an upper internal node and each of the subscription information corresponds to and only corresponds to one leaf node in one tree structure, the obtained tree structures are unique for the same set of subscription information and predicates. With the above method, the tree structures for the subscription information can be created. Since each of the subscription information corresponds to only one leaf node in one tree structure, the storage space consumed by the system can be reduced.

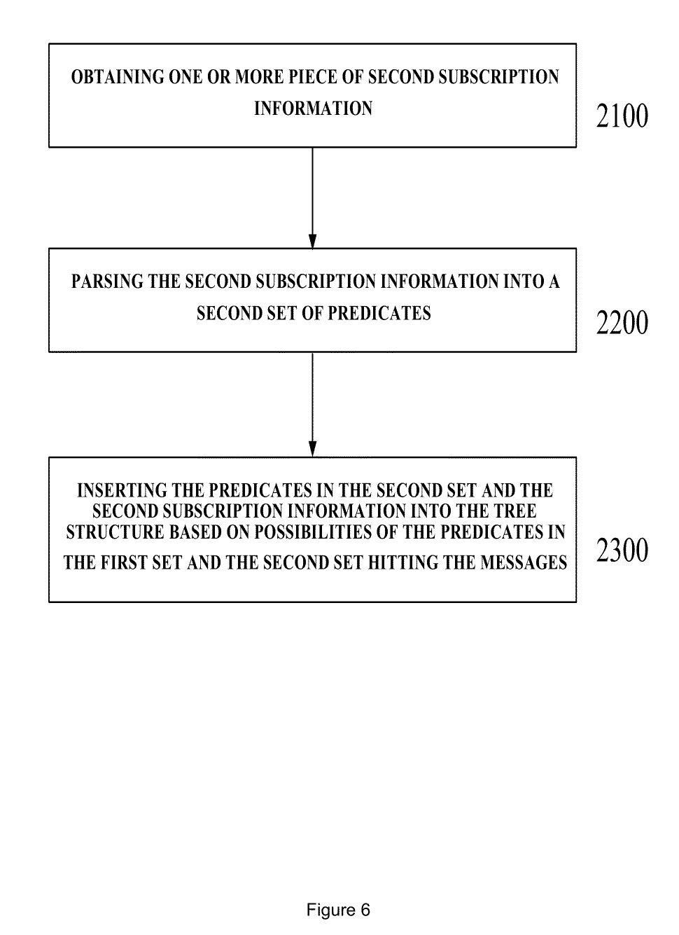

FIG. 6 shows a flowchart of a method for processing subscription information according to an embodiment of the present invention. With this embodiment, new subscription information can be inserted conveniently into the existing tree structure of the subscription information and predicates.

As shown in FIG. 6, in step 2100, one or more pieces of second subscription information can be obtained. In step 2200, the second subscription information is parsed into a second set of predicates. In step 2300, the predicates in the second set and the second subscription information are inserted into the tree structure based on possibilities of the predicates in the first set and the second set hitting the messages such that the possibility of the predicate for a lower internal node in the tree structure hitting the messages is higher than that of an upper internal node, the second subscription information corresponds to and only corresponds to one leaf node in one tree structure, and the second subscription information corresponds to all information of the predicates in a branch of the leaf node in the tree structure thereof from the root node.

In one embodiment, if the predicate of the second set of predicates does not exist in the first set of predicates, an internal node will be created in the tree structure, and the predicate in the second set will be incorporated into the first set. When new subscription information is obtained next time, the updated first set of predicates will be treated as the first set of predicates for operation. If one predicate of the second set of predicates exists in the first set of predicates, no internal node will be created in the tree structure.

In one embodiment, the subscription information is divided into the set of predicates in a disjunctive normal form (DNF). A disjunctive normal form is a standardization (or normalization) of a logical formula which is a disjunction of conjunctive clauses. A logical formula is considered to be in DNF if and only if it is a disjunction of one or more conjunctions of one or more literals. The only propositional operators in DNF are AND, OR, and NOT, for example, all of the following formulas are in DNF: (A∩B)∪C, and A∪B. The subscription information is divided into the set of predicates in the disjunctive normal form, so that the subscription information can be expressed as a union of a plurality of predicates connected by logical AND operation, which facilitates the process for matching a message with subscription information described later.

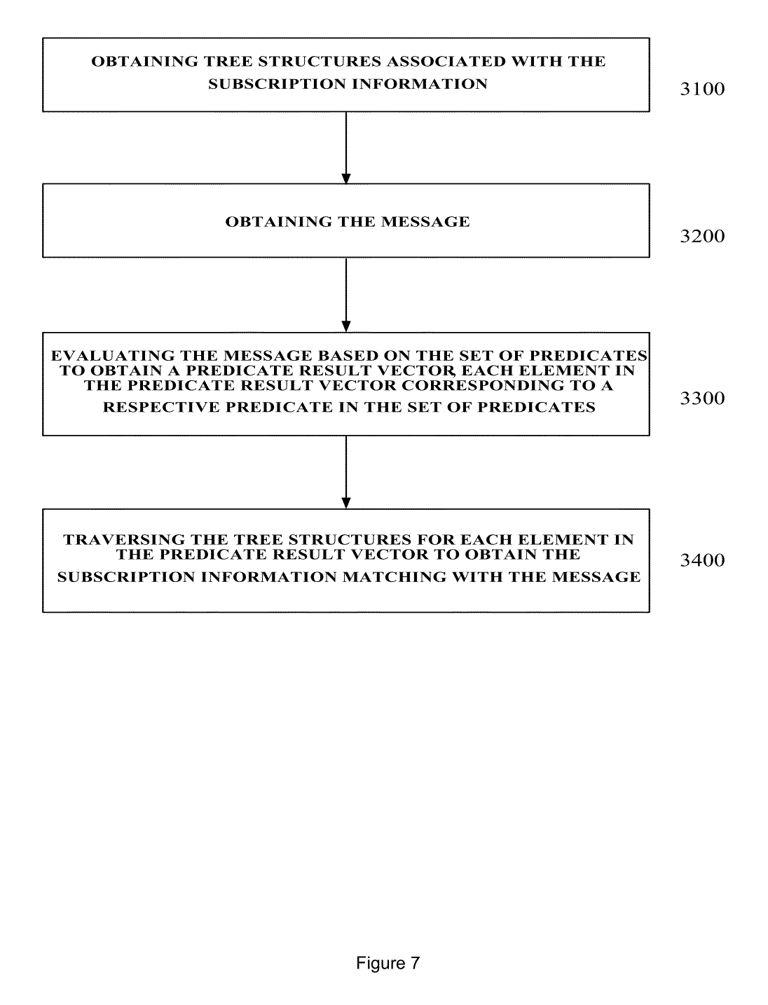

FIG. 7 shows a flowchart of a method for matching a message with subscription information according to an embodiment of the present invention.

As shown in FIG. 7, In step 3100, tree structures associated with the subscription information are obtained. The subscription information is parsed into a set of predicates, the predicates in the set are not repetitive. The tree structures are constructed for the predicates in the set and the subscription information based on possibilities of the predicates in the set hitting messages. Internal nodes in the tree structure including a root node represent the predicates, leaf nodes of the tree structure represent the subscription information. The possibility of the predicate for a lower internal node in the tree structure hitting the messages is higher than that of an upper internal node. Each of the subscription information corresponds to only one leaf node in one tree structure, and each of the subscription information corresponds to all information of the predicates in a branch of the leaf node in the tree structure thereof from the root node.

In step 3200, the message is obtained. In one embodiment, this method may be used in the internet of things, and the message may be the message in the internet of things.

Next, in step 3300, the message is evaluated based on the set of predicates to obtain a predicate result vector, each element in the predicate result vector corresponding to a respective predicate in the set of predicates. The process in step 3300 is similar to that of the first phase of the method of “two phases” in the prior art. If the message hits a predicate (i.e., satisfies with the predicate), for example, the value of the corresponding bit in the predicate result vector may be assumed as one, otherwise, the value may be assumed as zero. Those skilled in the art can understand that other values and expression forms may be selected to indicate whether the message hit the predicate or not.

In step 3400, the tree structures are traversed for each element in the predicate result vector to obtain the subscription information matching with the message. In the second phase of the method of “two phases” in the prior art, all the subscription information is traversed. However, in the method of the present invention, the tree structures are checked for each element in the predicate result vector, i.e., all the elements in the predicate result vector are traversed.

With the method of the present invention, based on the above tree structures, all the predicates, but not all the subscription information are traversed. Since in most cases, the number of predicates will not be increased as the number of the subscription information is increased in the case of a large quantity of subscription information, the operation speed of the present invention is higher than that of the method of “two phases” in the prior art.

In one embodiment, traversing the tree structures for each element in the predicate result vector to obtain the subscription information matching with the message may further include: if one element in the predicate result vector represents that the message hits the predicate, selecting the tree structures whose root node is the predicate corresponding to the element, pre-root traversing the tree structures and evaluating each leaf node to obtain the subscription matching with the message. Referring back to the tree structures of FIG. 5, pre-root traversing refers to traversing from the root nodes from top to bottom and from left to right.

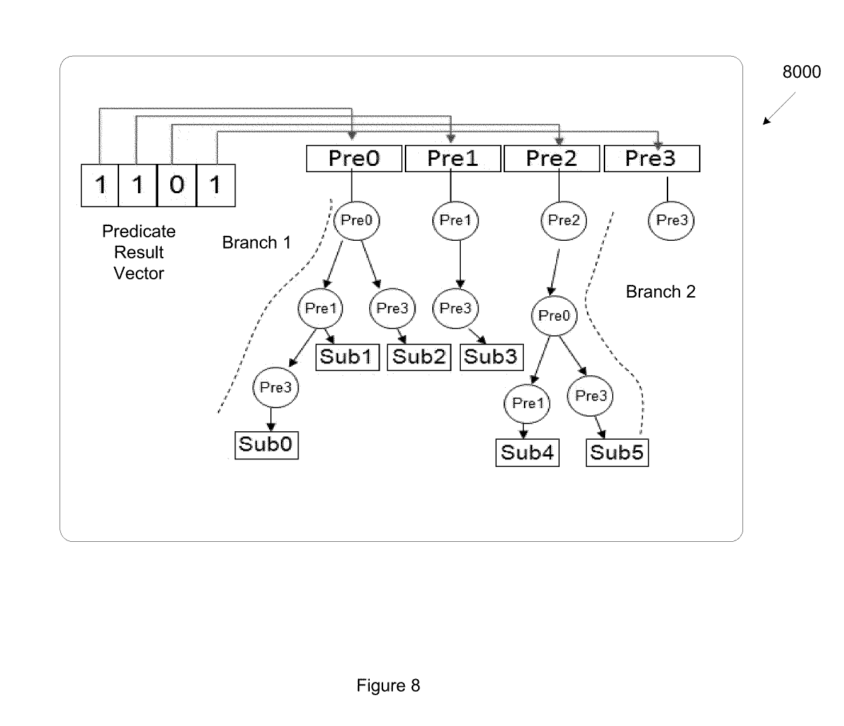

FIG. 8 shows a schematic view of a method 8000 for matching a message with subscription information according to an embodiment of the present invention. In this example, the exemplary tree structures shown in FIG. 5 are still used. The tree structures include six pieces of subscription information, i.e., Sub0, Sub1, . . . , Sub5. The obtained set of predicates include predicates Pre0, Pre1, Pre2 and Pre3. The first, second, third and fourth bits (from left to right) of the predicate result vector correspond to predicates Pre0, Pre1, Pre2 and Pre3 respectively. It is assumed that the predicate result vector of the obtained message is “1101”. The values of the first, second and fourth bits (from left to right) of the predicate result vector are “one”, indicating that the message hits the predicates Pre0, Pre1 and Pre3. The value of the third bit (from left to right) of the predicate result vector is “zero”, indicating that the message does not hit the predicate Pre2.

As to the first bit of the predicate result vector, since the value of this bit is “1” indicating that the message hits the predicate Pre0, the tree structure whose root node is the predicate Pre0 will be selected, and this tree structure will be pre-root traversed to evaluate each leaf node. As a result, it can be determined that the subscription information Sub1, Sub0 and Sub2 matches with the message.

Similarly, as to the second bit of the predicate result vector, the above operation is repeated. It can be determined that the subscription information Sub3 matches with the message.

As to the third bit of the predicate result vector, since the value of this bit is “0” indicating that the message does not hit the predicate Pre2, the tree structure whose root node is the predicate Pre2 will not be checked.

As to the fourth bit of the predicate result vector, although the value of this bit is “1” indicating that the message hits the predicate Pre3, there is no leaf node under the tree structure whose root node is the predicate Pre3, so no subscription information under this tree structure can be found to match with the message.

With the above operation, it can be determined that the subscription information matching with the obtained message is Sub1, Sub0, Sub2 and Sub3.

In addition, in one embodiment, traversing the tree structures for each element in the predicate result vector to obtain the subscription information matching with the message may further include: if the element in the predicate result vector for the predicate represented by one internal node in the tree structure indicates that the message does not hit the predicate, not traversing the subsequent nodes in a branch comprising the internal node.

For example, as to the exemplary tree structures as shown in FIG. 5, if the predicate result vector of the obtained message is “1001”, as to the first bit of the predicate result vector, there are predicates Pre0, Pre1 and Pre3 in “Branch 1”. Since the value of the corresponding bit in the predicate result vector for Pre1 is zero indicating that the message does not hit the predicate Pre1, the subsequent nodes of this node in this “Branch 1” will not be traversed. With this operation, the operation load can be reduced greatly, and the operation speed can be increased.

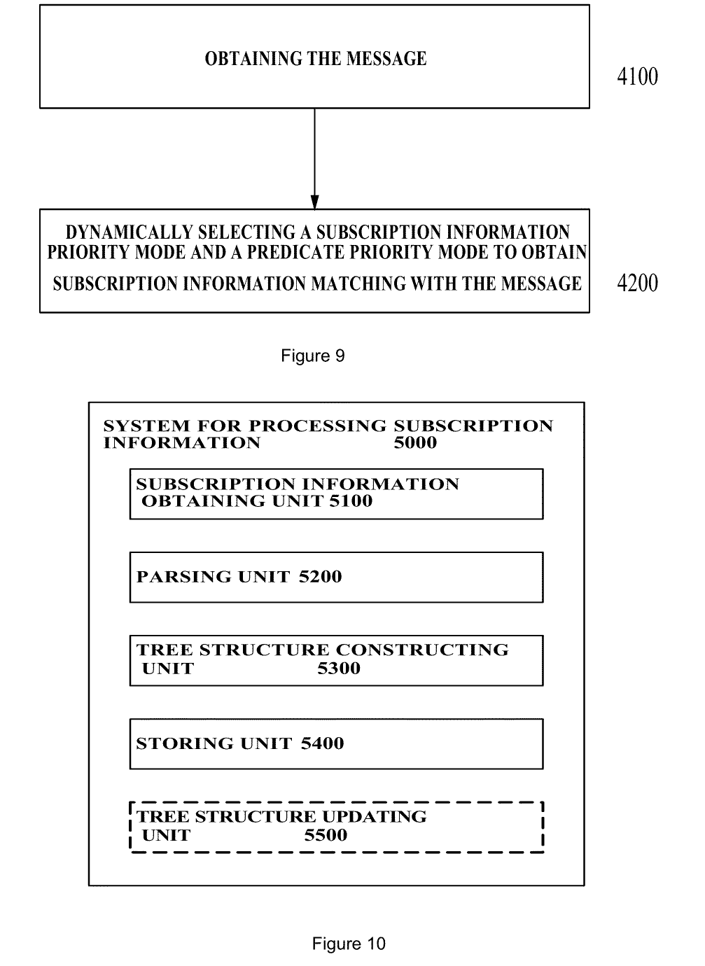

FIG. 9 shows a flowchart of a method for processing a message and subscription information according to an embodiment of the present invention.

As shown in FIG. 9, in 4100, the message is obtained. In one embodiment, this method may be used in the internet of things, and the message may the message in the internet of things. In step 4200, a subscription information priority mode and a predicate priority mode are dynamically selected to obtain subscription information matching with the message, whereby in the subscription information priority mode subscription information is obtained. The subscription information is parsed into a set of predicates, whereby the predicates in the set are not repetitive; the message is evaluated based on the set of predicates to obtain a predicate result vector, each element in the predicate result vector corresponding to a respective predicate in the set of predicates; and each subscription information is checked on a one-by-one basis for the predicate result vector to obtain the subscription information matching with the message; and in the predicate priority mode, the message is matched with subscription information using the above method of present invention.

Since the performance for the subscription information priority mode is well when the number of subscription information is small, and the performance for the predicate priority mode is well when the number of subscription information is large, in one embodiment, the predicate priority mode is selected when a number of the subscription information is greater than a predetermined threshold. Those skilled in the art can understand that the predetermined threshold can be determined according to experience or by experiments.

In one embodiment, the subscription information priority mode and the predicate priority mode may be dynamically selected according to a status of a queue of the messages. Since in various networks (such as the internet of things), messages are obtained continuously, and processed in a first-in-first-out manner, the number of the messages in the queue of the messages will be changed in different processing modes. The status of the queue of the messages may include the status of queue blocking, the status of queue dumping, etc. According to the method of the present invention, if the status of the message queue is deteriorated in one operation mode, another operation mode may be selected.

FIG. 10 shows a functional block diagram of a system 5000 for processing subscription information according to an embodiment of the present invention. All the functional blocks of the system 5000 (various units included in the system 5000, whether shown or not shown in the figure) may be implemented by hardware, software, or a combination of hardware and software to carry out the principles of the invention. It is understood by those skilled in the art that the functional blocks described in FIG. 10 may be combined or separated into sub-blocks to implement the principles of the invention as described above. Therefore, the description herein may support any possible combination or separation or further definition of the functional blocks described herein.

As shown in FIG. 10, according to one aspect of the present invention, the system 5000 for processing subscription information may include: a subscription information obtaining unit 5100, a parsing unit 5200, a tree structure constructing unit 5300 and a storing unit 5400. The subscription information obtaining unit 5100 may be configured to obtain one or more pieces of first subscription information. The parsing unit 5200 may be configured to parse the one or more pieces of first subscription information into a first set of predicates, wherein the predicates in the first set are not repetitive. The tree structure constructing unit 5300 may be configured to construct one or more tree structures for the predicates in the first set and the first subscription information based on possibilities of the predicates in the first set hitting messages, whereby internal nodes in the tree structure including a root node represent the predicates, leaf nodes of the tree structure represent the subscription information, the possibility of the predicate for a lower internal node in the tree structure hitting the messages is higher than that of an upper internal node, each of the first subscription information corresponds to and only corresponds to one leaf node in one tree structure, and each of the first subscription information corresponds to all information of the predicates in a branch of the leaf node in the tree structure thereof from the root node. The storing unit 5400 may be configured to store the one or more tree structures for matching with the message.

In one embodiment, the subscription information obtaining unit 5100 may be further configured to obtain second subscription information. The parsing unit 5200 may be further configured to parsing the second subscription information into a second set of predicates. The system 5000 may further comprise a tree structure updating unit 5500 configured to insert the predicates in the second set and the second subscription information into the tree structure based on possibilities of the predicates in the first set and the second set hitting the messages such that the possibility of the predicate for a lower internal node in the tree structure hitting the messages is higher than that of an upper internal node, the second subscription information corresponds to and only corresponds to one leaf node in one tree structure, and the second subscription information corresponds to all information of the predicates in a branch of the leaf node in the tree structure thereof from the root node.

In one embodiment, if the predicate of the second set of predicates does not exist in the first set of predicates, an internal node is created in the tree structure, and the predicate in the second set will be incorporated into the first set. In one embodiment, if one predicate of the second set of predicates exists in the first set of predicates, no internal node will be created in the tree structure

In one embodiment, the subscription information is divided into the set of predicates in a disjunctive normal form.

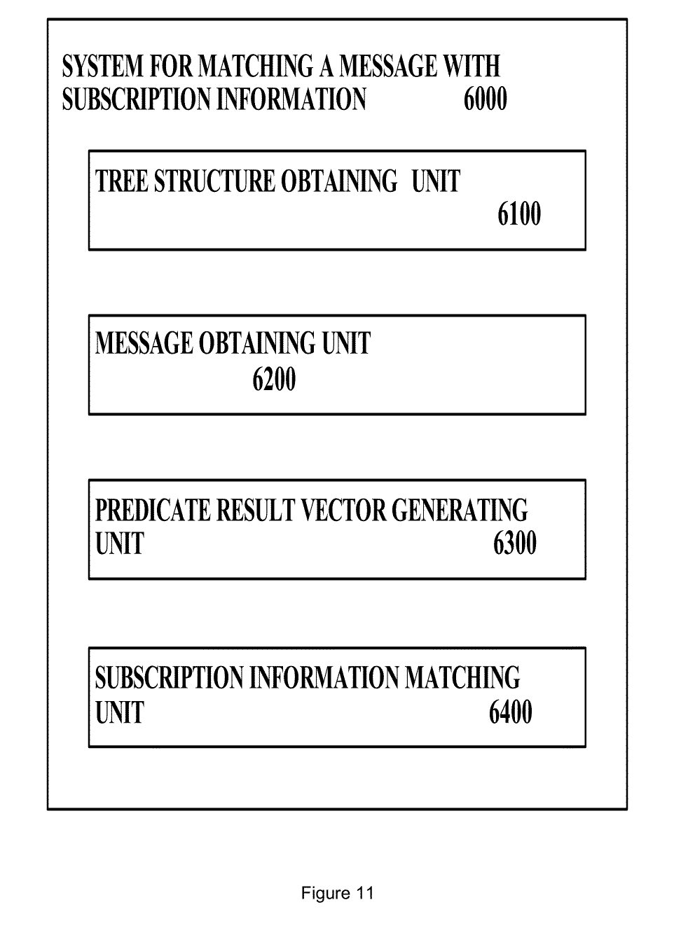

FIG. 11 shows a functional block diagram of a system 6000 for matching a message with subscription information according to an embodiment of the present invention. All the functional blocks of the system 6000 (various units included in the system 6000, whether shown or not shown in the figure) may be implemented by hardware, software, or a combination of hardware and software to carry out the principles of the invention. It is understood by those skilled in the art that the functional blocks described in FIG. 11 may be combined or separated into sub-blocks to implement the principles of the invention as described above. Therefore, the description herein may support any possible combination or separation or further definition of the functional blocks described herein.

As shown in FIG. 11, according to one aspect of the present invention, the system 6000 for matching a message with subscription information may comprise: a tree structure obtaining unit 6100, a message obtaining unit 6200, a predicate result vector generating unit 6300 and a subscription information matching unit 6400. The tree structure obtaining unit 6100 may be configured to obtain tree structures associated with the subscription information, wherein the subscription information is parsed into a set of predicates, the predicates in the set are not repetitive, the tree structures are constructed for the predicates in the set and the subscription information based on possibilities of the predicates in the set hitting messages, internal nodes in the tree structure including a root node represent the predicates, leaf nodes of the tree structure represent the subscription information, the possibility of the predicate for a lower internal node in the tree structure hitting the messages is higher than that of an upper internal node, each of the subscription information corresponds to and only corresponds to one leaf node in one tree structure, and each of the subscription information corresponds to all information of the predicates in a branch of the leaf node in the tree structure thereof from the root node. The message obtaining unit 6200 may be configured to obtain the message. The predicate result vector generating unit 6300 may be configured to evaluate the message based on the set of predicates to obtain a predicate result vector, each element in the predicate result vector corresponding to a respective predicate in the set of predicates. The subscription information matching unit 6400 may be configured to traverse the tree structures for each element in the predicate result vector to obtain the subscription information matching with the message.

In one embodiment, the subscription information matching unit 6400 may be further configured to: if one element in the predicate result vector represents that the message hits the predicate, select the tree structures whose root node is the predicate corresponding to the element, pre-root traverse the tree structures and evaluate each leaf node to obtain the subscription matching with the message.

In one embodiment, the subscription information matching unit 6400 may be further configured to: if the element in the predicate result vector for the predicate represented by one internal node in the tree structure indicates that the message does not hit the predicate, not traverse the subsequent nodes in a branch comprising the internal node.

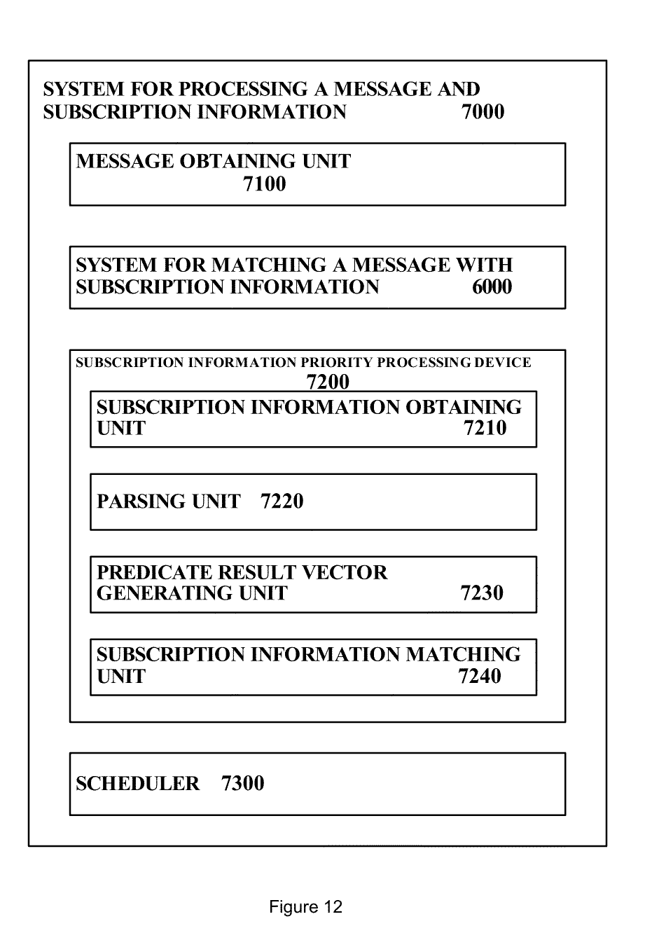

FIG. 12 shows a functional block diagram of a system 7000 for processing a message and subscription information according to an embodiment of the present invention. All the functional blocks of the system 7000 (various units included in the system 7000, whether shown or not shown in the figure) may be implemented by hardware, software, or a combination of hardware and software to carry out the principles of the invention. It is understood by those skilled in the art that the functional blocks described in FIG. 12 may be combined or separated into sub-blocks to implement the principles of the invention as described above. Therefore, the description herein may support any possible combination or separation or further definition of the functional blocks described herein.

As shown in FIG. 12, according to one aspect of the present invention, the system 7000 for processing a message and subscription information may comprise: a message obtaining unit 7100, the above system 6000 for matching a message with subscription information, a subscription information priority processing device 7200 and a scheduler 7300. The message obtaining unit 7100 may be configured to obtain the message. The subscription information priority processing device 7200 may comprise: a subscription information obtaining unit 7210 configured to obtain the subscription information; a parsing unit 7220 configured to parse the subscription information into a set of predicates, wherein the predicates in the set are not repetitive; a predicate result vector generating unit 7230 configured to evaluate the message based on the set of predicates to obtain a predicate result vector, each element in the predicate result vector corresponding to a respective predicate in the set of predicates; and a subscription information matching unit 7240 configured to check each subscription information on a one-by-one basis for the predicate result vector to obtain the subscription information matching with the message. The scheduler 7300 may be configured to dynamically select the subscription information priority processing device 7200 and the above system 6000 for matching a message with subscription information to obtain the subscription information matching with the message.

In one embodiment, the scheduler 7300 may select the above system 6000 for matching a message with subscription information to obtain the subscription information matching with the message when a number of the subscription information is greater than a predetermined threshold.

In one embodiment, the scheduler 7300 may dynamically select the subscription information priority processing device 7200 and the above system 6000 for matching a message with subscription information to obtain the subscription information matching with the message according to a status of a queue of the messages.

Those skilled in the art can understand that the present invention is applicable to not only the internet of things, but also other various network, such as Internet, the internet of vehicles, etc.

Various embodiments of the invention may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although preferred embodiments have been depicted and described in detail herein, it will be apparent to those skilled in the relevant art that various modifications, additions, substitutions and the like can be made without departing from the spirit of the disclosure, and these are, therefore, considered to be within the scope of the disclosure, as defined in the following claims.

What is claimed is:

1. A method for processing subscription information comprising:
obtaining one or more pieces of first subscription information;
parsing the one or more pieces of first subscription information into a first set of predicates, wherein the first set of predicates are not repetitive;
constructing one or more tree structures for the first set of predicates based on possibilities of the first set of predicates hitting one or more messages, the one or more tree structures including: a root node representing the first set of predicates, a leaf node representing the first subscription information, and a statistical possibility; and
storing the one or more tree structures for matching with the one or more messages.

2. The method of claim 1, where the statistical possibility comprises a possibility of hitting the one or more messages being higher for a predicate in a lower internal node in the tree structure than for a predicate in an upper internal node.

3. The method of claim 1 further comprising:
obtaining second subscription information;
parsing the second subscription information into a second set of predicates; and
inserting the second set of predicates and the second subscription information into the tree structure based on possibilities of the predicates in the first set and the second set hitting the messages such that the possibility of the predicate for the lower internal node in the tree structure hitting the messages is higher than that of the upper internal node, the second subscription information corresponds to only one leaf node in one tree structure, and the second subscription information corresponds to all information of the predicates in a branch of the leaf node in the tree structure thereof from the root node.

4. The method of claim 3, wherein the internal node is created in the tree structure and the predicate in the second set is incorporated into the first set based on the predicate of the second set of predicates not existing in the first set of predicates.

5. The method of claim 1, wherein the subscription information is parsed into the set of predicates in a disjunctive normal form.

6. A method of matching a message with subscription information comprising:
obtaining tree structures associated with the subscription information,
wherein the subscription information is parsed into a set of predicates;
obtaining the message;
evaluating the message based on the set of predicates to obtain a predicate result vector, each element in the predicate result vector corresponding to a respective predicate in the set of predicates; and
traversing the tree structures for each element in the predicate result vector to obtain the subscription information matching with the message.

7. The method of claim 6, wherein the predicates are not repetitive, the tree structures are constructed for the set of predicates and the subscription information, based on possibilities of the predicates in the set hitting messages.

8. The method of claim 6, wherein traversing the tree structures further comprises:
based on one element in the predicate result vector representing that the message hits the predicate, selecting the tree structures whose root node is a predicate corresponding to the element in the predicate result vector, pre-root traversing the tree structures and evaluating each leaf node to obtain the subscription matching with the message.

9. The method of claim 6, wherein internal nodes in the tree structure represent the predicates, leaf nodes of the tree structure represent the subscription information, the possibility of the predicate for a lower internal node in the tree structure hitting the messages is higher than that of an upper internal node, each of the subscription information corresponds to only one leaf node in one tree structure, and each of the subscription information corresponds to all information of the predicates in a branch of the leaf node in the tree structure thereof from the root node.

10. A computer system for processing subscription information, the computer system comprising:
one or more processors, one or more computer-readable memories, one or more computer-readable tangible storage devices, and program instructions stored on at least one of the one or more computer-readable tangible storage devices for execution by at least one of the one or more processors via at least one of the one or more memories, the program instructions comprising:
program instructions to obtain one or more pieces of first subscription information;
program instructions to parse the one or more pieces of first subscription information into a first set of predicates, wherein predicates in the first set of predicates are not repetitive;
program instructions to construct one or more tree structures for the predicates in the first set of predicates and the first subscription information based on possibilities of the predicates in the first set of predicates hitting messages, the one or more tree structures including: a root node representing the predicates, leaf nodes representing the subscription information, and a statistical possibility; and
program instructions to store the one or more tree structures for matching with the messages.

11. The computer system of claim 10, wherein the statistical possibility comprises a possibility of hitting the one or more messages being higher for a predicate in a lower internal node in the tree structure than for a predicate in an upper internal node.

12. The computer system of claim 10, wherein:
the program instructions to obtain one or more pieces of first subscription include program instructions to obtain second subscription information;
the program instructions to parse the one or more pieces of first subscription information include program instructions to parse the second subscription information into a second set of predicates; and
the program instructions to construct one or more tree structures include program instructions to insert the second set of predicates and the second subscription information into the one or more tree structures based on possibilities of the predicates in the first set of predicates and the predicates in the second set of predicates hitting the messages such that a possibility of a predicate for the lower internal node in the tree structure hitting the messages is higher than that of the upper internal node, the second subscription information corresponds to only one leaf node in one tree structure, and the second subscription information corresponds to all information of the predicates in a branch of the leaf node in the tree structure thereof from the root node.

13. The computer system of claim 12, wherein based on the predicate of the second set of predicates not existing in the first set of predicates, creating an internal node in the tree structure, and incorporating the predicate in the second set of predicates into the first set of predicates.

14. The computer system of claim 10, wherein the subscription information is parsed into the set of predicates in a disjunctive normal form.
